(19) United States
(12) Patent Application Publication
(10) Pub. No.: US 2025/0232615 A1
(43) Pub. Date: Jul. 17, 2025

(54) MANAGEMENT APPARATUS, MANAGEMENT METHOD, AND NON-TRANSITORY COMPUTER-READABLE MEDIUM

(71) Applicant: NEC Corporation, Minato-ku, Tokyo (JP)

(72) Inventors: Noboru YOSHIDA, Tokyo (JP); Ryo KAWAI, Tokyo (JP); Jinquan LIU, Tokyo (JP)

(73) Assignee: NEC Corporation, Minato-ku, Tokyo (JP)

(21) Appl. No.: 18/730,833

(22) PCT Filed: Feb. 7, 2022
(86) PCT No.: PCT/JP2022/004696

§ 371 Date: Jul. 22, 2024

(51) Int. Cl. G06V 40/20; G06V 10/74; G06V 20/52

(52) U.S. Cl. CPC G06V 40/23; G06V 10/761; G06V 20/52

(57) ABSTRACT

A management apparatus includes a motion detection means, a correspondence specifying means, an appropriateness calculation means, and an output means. The motion detection means detects a first motion performed by a first worker and a second motion performed by a second worker different from the first worker, the first and second workers being included in an image obtained by capturing a plurality of workers at a place where predetermined work is performed. The correspondence specifying means specifies a correspondence including at least one of a time and a position of the first motion and the second motion. The appropriateness calculation means calculates an appropriateness of the work based on the correspondence. The output means outputs appropriateness information including the calculation result.

### TECHNICAL FIELD

The present disclosure relates to a management apparatus, a management method, and a computer-readable medium.

### BACKGROUND ART

When a plurality of workers perform work in cooperation in a predetermined space such as a construction site, a technique for monitoring that appropriate cooperation work is performed is desired.

For example, Patent Literature 1 discloses a technique in which an input from an operation input unit is not accepted when a detected motion is directed from the driver's seat side of the vehicle toward the operation input unit and the input is accepted when the detected motion is directed from a seat other than the driver's seat toward the operation input unit.

Patent Literature 2 discloses a technique in which motion information is compared with reference motion information to extract motion information satisfying predetermined conditions and a scene, in which a worker is performing a motion indicated by the extracted motion information, is displayed using a moving image.

Patent Literature 3 discloses a technique in which it is determined whether or not a motion command on the user A side corresponds to a motion command on the user X side and a motion corresponding to the motion command is performed.

### CITATION LIST

### Patent Literature

Patent Literature 1: Japanese Unexamined Patent Application Publication No. 2020-079011
Patent Literature 2: Japanese Unexamined Patent Application Publication No. 2019-125023
Patent Literature 3: Japanese Unexamined Patent Application Publication No. 2006-039917

### SUMMARY OF INVENTION

### Technical Problem

However, since workers in the field perform various motions, it is difficult to comprehensively manage the appropriateness of work by integrating various viewpoints. In addition, as a technique for maintaining safety of work performed by a plurality of workers in cooperation, a simpler technique is required.

In view of the aforementioned problems, an object of the present disclosure is to provide a management system and the like that can efficiently and easily manage the appropriateness of work performed by a plurality of workers in cooperation.

### Solution to Problem

A management apparatus according to an aspect of the present disclosure includes a motion detection means, a correspondence specifying means, an appropriateness calculation means, and an output means. The motion detection means detects a first motion performed by a first worker and a second motion performed by a second worker different from the first worker, the first and second workers being included in an image obtained by capturing a plurality of workers at a place where predetermined work is performed. The correspondence specifying means specifies a correspondence including at least one of a time and a position of the first motion and the second motion. The appropriateness calculation means calculates an appropriateness of the work based on the correspondence. The output means outputs appropriateness information including the calculation result.

In a management method according to an aspect of the present disclosure, a computer executes the following method. The computer detects a first motion performed by a first worker and a second motion performed by a second worker different from the first worker, the first and second workers being included in an image obtained by capturing a plurality of workers at a place where predetermined work is performed. The computer specifies a correspondence including at least one of a time and a position of the first motion and the second motion. The computer calculates an appropriateness of the work based on the correspondence. The computer outputs appropriateness information including the calculation result.

A computer-readable medium according to an aspect of the present disclosure stores a program for causing a computer to execute the following management method. The computer detects a first motion performed by a first worker and a second motion performed by a second worker different from the first worker, the first and second workers being included in an image obtained by capturing a plurality of workers at a place where predetermined work is performed. The computer specifies a correspondence including at least one of a time and a position of the first motion and the second motion. The computer calculates an appropriateness of the work based on the correspondence. The computer outputs appropriateness information including the calculation result.

### Advantageous Effects of Invention

According to the present disclosure, it is possible to provide a management system and the like that can efficiently and easily manage the appropriateness of work performed by a plurality of workers in cooperation.

### BRIEF DESCRIPTION OF DRAWINGS

FIG. 1 is a block diagram of a management apparatus according to a first example embodiment.

FIG. 2 is a flowchart illustrating a management method according to the first example embodiment.

FIG. 3 is a diagram illustrating the overall configuration of a management system according to a second example embodiment.

FIG. 4 is a diagram illustrating skeleton data extracted from image data.

FIG. 5 is a diagram for explaining a registered motion database according to the second example embodiment.

FIG. 6 is a diagram for explaining a first example of a registered motion according to the second example embodiment.

FIG. 7 is a diagram for explaining a second example of the registered motion according to the second example embodiment.

FIG. 8 is a diagram for explaining a correspondence database according to the second example embodiment.

FIG. 9 is a diagram illustrating a first example of an image captured by a camera.

FIG. 10 is a first diagram illustrating skeleton data extracted by the management apparatus.

FIG. 11 is a second diagram illustrating skeleton data extracted by the management apparatus.

FIG. 12 is a diagram in which skeleton data is superimposed on a second example of an image captured by a camera.

FIG. 13 is a diagram for explaining an example of a rule of a positional relationship in correspondence data.

FIG. 14 is a diagram for explaining a second example of the correspondence database.

FIG. 15 is a diagram illustrating an image according to a second example of the correspondence database.

FIG. 16 is a diagram illustrating the overall configuration of a management system according to a third example embodiment.

FIG. 17 is a diagram illustrating an example of a correspondence database according to a third example embodiment.

FIG. 18 is a diagram illustrating the overall configuration of a management system according to a fourth example embodiment.

FIG. 19 is a block diagram of an authentication apparatus according to the fourth example embodiment.

FIG. 20 is a flowchart illustrating a management method according to the fourth example embodiment.

FIG. 21 is a block diagram illustrating the hardware configuration of a computer.

### EXAMPLE EMBODIMENT

Hereinafter, the present disclosure will be described through example embodiments, but the disclosure according to the claims is not limited to the following example embodiments. In addition, not all the configurations described in the example embodiments are essential as means for solving the problem. In the diagrams, the same elements are denoted by the same reference numerals, and repeated description is omitted as necessary.

### First Example Embodiment

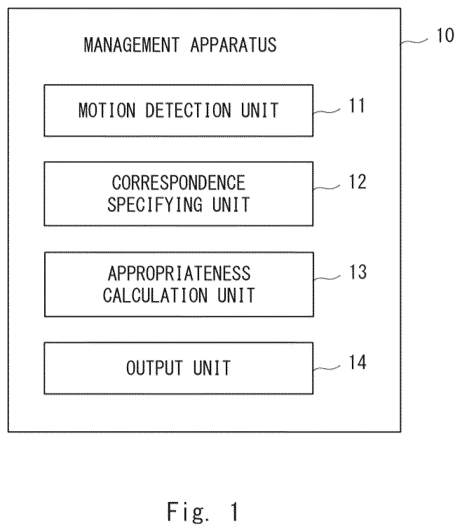

First, a first example embodiment of the present disclosure will be described. FIG. 1 is a block diagram of a management apparatus 10 according to the first example embodiment. The management apparatus 10 illustrated in FIG. 1 manages work of a worker by, for example, analyzing a posture or a motion of a person included in an image captured by a camera installed at a predetermined work site and calculating the appropriateness of the work or the like performed by the person.

The management apparatus 10 includes a motion detection unit 11, a correspondence specifying unit 12, an appropriateness calculation unit 13, and an output unit 14 as main components. In addition, in the present disclosure, “posture” refers to a form in at least a part of a body, and “motion” refers to a state of taking a predetermined posture along time. The “motion” is not limited to a case where the posture changes, and includes a case where a constant posture is maintained. Therefore, simply referring to “motion” may include a posture.

The motion detection unit 11 detects a motion of a worker included in image data of an image obtained by capturing a plurality of workers with a camera at a place where a predetermined work is performed. At this time, in a case where a plurality of workers are included in the image, the motion detection unit 11 detects the motion of each worker. That is, for example, in a case where a first worker and a second worker are included in the image, the motion detection unit 11 detects a first motion performed by the first worker and a second motion performed by the second worker different from the first worker. The image data is image data according to a plurality of consecutive frames obtained by capturing a worker performing a series of motions. The image data is, for example, image data according to a predetermined format such as H. 264 or H. 265. That is, the image data may be a still image or a moving image.

The predetermined motion detected by the motion detection unit 11 is estimated from, for example, an image of the body of a person who is a worker extracted from the image data. The motion detection unit 11 detects that the person is performing predetermined work from the image of the body of the person. It is preferable that the predetermined work is, for example, a pattern of a preset work and may be performed at a work site.

The correspondence specifying unit 12 specifies the correspondence between the first motion and the second motion described above. The correspondence relates to at least one of time and position. The correspondence specifying unit 12 specifies the correspondence from the image data. That is, for example, the correspondence specifying unit 12 acquires information regarding the time of the frame of the image data regarding the first motion and the second motion, and associates the information regarding the time with the time of each motion.

The time-dependent correspondence between the first motion and the second motion may indicate, for example, that either the first motion or the second motion starts or ends first. The time-dependent correspondence between the first motion and the second motion may indicate, for example, that the first motion and the second motion start or end simultaneously. Alternatively, the time-dependent correspondence between the first motion and the second motion may indicate, for example, the progress of the first motion and the second motion by time. That is, the above-described correspondence regarding the time may indicate, for example, a difference between start times, a difference between end times, or a difference between times elapsed from the start time to the end time. In addition, in this case, the time may be indicated by a frame in the image data. In addition, “start” and “end” of the above-described motion may mean start or end of the motion itself, or may mean that the motion detection unit 11 has started or ended the detection.

The correspondence between the positions of the first motion and the second motion is a positional relationship between the first worker related to the first motion and the second worker related to the second motion detected in the image data. The correspondence specifying unit 12 may calculate or refer to the positional relationship by analyzing the angle of view, angle, and the like of the image from a predetermined object or scenery included in the image captured by the camera.

In addition, the positional relationship in the present disclosure may correspond to an actual three-dimensional space related to a captured image. The positional relationship may be calculated by estimating a three-dimensional space in a pseudo manner in the captured image. The positional relationship may be a positional relationship on a plane of the captured image. The appropriateness calculation unit 13 may calculate or refer to the above-described positional relationship by setting an angle of view, an angle, or the like of an image captured by the camera in advance.

The positional relationship is, for example, a distance between persons related to the detected motion. In addition, the positional relationship may indicate, for example, a positional relationship related to a predetermined position of the body of the person related to the detected motion.

The appropriateness calculation unit 13 calculates the appropriateness of the work performed by the person included in the image captured by the camera. When performing this calculation, the appropriateness calculation unit 13 refers to the motion detected by the motion detection unit 11. In addition, when performing this calculation, the appropriateness calculation unit 13 refers to the detected first motion and second motion and the correspondence. As a result, the appropriateness calculation unit 13 calculates the appropriateness of the work. The appropriateness may be indicated as a plurality of levels by an index such as a value, a score, or a symbol in a predetermined range, for example. The appropriateness may be indicated by, for example, a binary value of “appropriate” and “not appropriate”.

The output unit 14 outputs the appropriateness information including the calculation result performed by the appropriateness calculation unit 13. In this case, the appropriateness information may indicate, as a result of the calculation, a score for evaluating the work performed by the first worker and the second worker whose motions have detected. The appropriateness information may indicate that the work performed by the first worker and the second worker is appropriate or not appropriate. The output unit 14 may output the above-described appropriateness information to, for example, a display device (not illustrated) included in the management apparatus 10. The output unit 14 may output the above-described appropriateness information to an external apparatus communicably connected to the management apparatus 10.

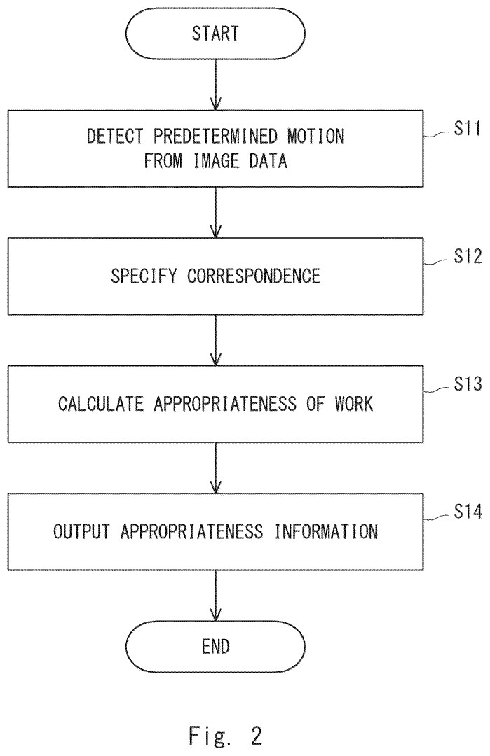

Next, processing performed by the management apparatus 10 will be described with reference to FIG. 2. FIG. 2 is a flowchart illustrating a management method according to the first example embodiment. The flowchart illustrated in FIG. 2 is started when the management apparatus 10 acquires image data, for example.

First, the motion detection unit 11 detects a first motion performed by a first worker included in image data of an image obtained by capturing a plurality of workers at a place where predetermined work is performed and a second motion performed by a second worker different from the first worker (step S11). When the predetermined motion performed by the person is detected, the motion detection unit 11 supplies information regarding the detected motion to the correspondence specifying unit 12 and the appropriateness calculation unit 13.

Then, the correspondence specifying unit 12 specifies a correspondence including at least one of time and position of the first motion and the second motion (step S12). The correspondence specifying unit 12 supplies information regarding the specified correspondence to the appropriateness calculation unit 13.

Then, the appropriateness calculation unit 13 calculates the appropriateness of the work with reference to the detected first motion and second motion and the correspondence (step S13). When the appropriateness information including the calculation result is generated, the appropriateness calculation unit 13 supplies the generated appropriateness information to the output unit 14.

Then, the output unit 14 outputs the appropriateness information received from the appropriateness calculation unit 13 to a predetermined output destination (step S14). When the appropriateness information is output from the output unit 14, the management apparatus 10 ends a series of processing.

In addition, in the above-described processing, the order of steps S11 and S12 may be reversed, or steps S11 and S12 may be executed simultaneously or may be executed in parallel.

Although the first example embodiment has been described above, the configuration of the management apparatus 10 is not limited to the above-described configuration. For example, the management apparatus 10 includes a processor and a storage device as components (not illustrated). Examples of the storage device include a storage device including a non-volatile memory such as a flash memory or a solid state drive (SSD). In this case, the storage device included in the management apparatus 10 stores a computer program (hereinafter, also simply referred to as a program) for executing the above-described management method. In addition, the processor reads a computer program from the storage device into a buffer memory such as a dynamic random access memory (DRAM), and executes the program.

Each component of the management apparatus 10 may be implemented by dedicated hardware. In addition, some or all of the components may be implemented by general-purpose or dedicated circuitry, a processor, and the like, or a combination thereof. These may be implemented by a single chip or may be implemented by a plurality of chips connected to each other through a bus. Some or all of the components of each apparatus may be implemented by a combination of the above-described circuit and the like and a program. In addition, as the processor, a central processing unit (CPU), a graphics processing unit (GPU), a field-programmable gate array (FPGA), and the like can be used. In addition, the description regarding the configuration described herein can also be applied to other apparatuses or systems described below in the present disclosure.

In addition, in a case where some or all of the components of the management apparatus 10 are implemented by a plurality of information processing apparatuses, circuits, and the like, the plurality of information processing apparatuses, circuits, and the like may be arranged in a centralized manner or in a distributed manner. For example, the information processing apparatuses, the circuits, and the like may be implemented in the form of a client server system, a cloud computing system, or the like in which these are connected to each other through a communication network. In addition, the function of the management apparatus 10 may be provided in a software as a service (Saas) format. In addition, the above-described method may be stored in a computer-readable medium to cause a computer to perform the method.

As described above, according to the present example embodiment, it is possible to provide a management system and the like that can efficiently and easily manage the appropriateness of work performed by a plurality of workers in cooperation.

### Second Example Embodiment

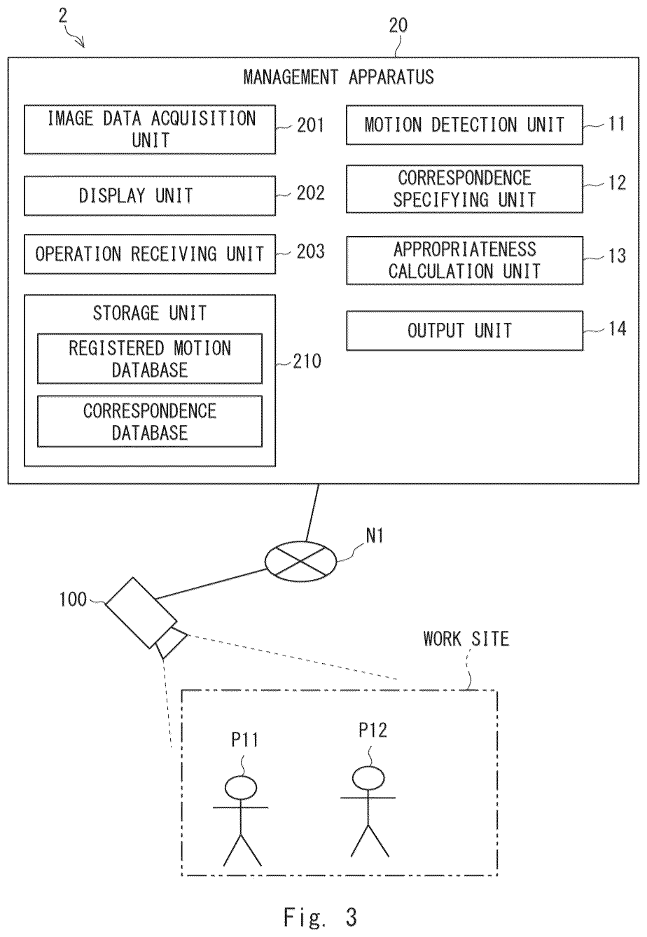

Next, a second example embodiment of the present disclosure will be described. FIG. 3 is a diagram illustrating the overall configuration of a management system 2 according to the second example embodiment. The management system 2 includes a management apparatus 20 and a camera 100.

The management apparatus 20 and the camera 100 are communicably connected to each other through a network N1.

The camera 100 may be referred to as an imaging apparatus. The camera 100 includes an objective lens and an image sensor, and captures an image of a work site installed every predetermined period. At the work site captured by the camera 100, for example, there are a first worker P11 and a second worker P12 who are workers. The camera 100 captures at least parts of the bodies of the first worker P11 and the second worker P12 by capturing the work site. In the following description, a plurality of workers may be simply referred to as workers. The first worker P11 and the second worker P12 may be simply referred to as operators.

The camera 100 generates image data corresponding to each captured image, and sequentially supplies the image data to the management apparatus 20 through the network N1. The predetermined period is, for example, 1/15 second, 1/30 second, 1/60 second, or the like, but is not limited thereto. The camera 100 may have a function such as panning, tilting, or zooming.

The management apparatus 20 is a computer apparatus having a communication function, such as a personal computer, a tablet PC, or a smartphone. The management apparatus 20 includes an image data acquisition unit 201, a display unit 202, an operation receiving unit 203, and a storage unit 210 in addition to the configuration described in the first example embodiment.

The motion detection unit 11 according to the present example embodiment extracts skeleton data of the first worker P11 and the second worker P12 from the image data. More specifically, the motion detection unit 11 detects an image area (body area) of the body of the person, who is a worker, from the frame image included in the image data, and extracts (for example, cuts out) the image area as a body image. Then, the motion detection unit 11 extracts skeleton data of at least a part of the body of the person based on the characteristics of joints and the like of the person recognized in the body image using a skeleton estimation technique using machine learning. The skeletal information is information including a “key point” that is a characteristic point such as a joint and a “bone link” indicating a link between the key points. The motion detection unit 11 may use, for example, a skeleton estimation technique such as OpenPose. In the present disclosure, the bone link described above may be simply referred to as a “bone”. The bone means a pseudo skeleton.

The motion detection unit 11 detects a predetermined posture or motion from the extracted skeleton data of the first worker P11 and the second worker P12. When detecting the posture or the motion, the motion detection unit 11 searches for a registered motion registered in a registered motion database stored in the storage unit 210, and compares the skeleton data related to the searched registered motion with the skeleton data of the worker. Then, in a case where the skeleton data of the worker is similar to the skeleton data related to the registered motion, the motion detection unit 11 recognizes the skeleton data as a predetermined posture or motion. That is, in a case where a registered motion similar to the skeleton data of the person is detected, the motion detection unit 11 recognizes the motion related to the skeleton data as a predetermined posture or motion in association with the registered motion. That is, the motion detection unit 11 recognizes the type of the motion of the worker by associating the skeleton data of the worker with the registered motion.

In the following description, the motion performed by the first worker P11 is referred to as a first motion, and the motion performed by the second worker P12 is referred to as a second motion. In addition, the first motion and the second motion may be collectively referred to simply as a motion.

In the above-described similarity determination, the motion detection unit 11 detects the first motion and the second motion by comparing the skeleton data related to the motion of the worker with the skeleton data as the registered motion for the forms of the elements forming the skeleton data. That is, the motion detection unit 11 detects the first motion and the second motion by calculating the similarity of the forms of the elements forming the skeleton data.

As a component of the skeleton data, a pseudo joint point or a skeleton structure for indicating the posture of the body is set. The forms of elements forming the skeleton data can also be referred to as, for example, a relative geometric relationship of positions, distances, angles, and the like of other key points or bones in a case where a predetermined key point or bone is used as a reference. Alternatively, the forms of elements forming the skeleton data can also be, for example, one integrated form formed by a plurality of key points or bones.

The motion detection unit 11 analyzes whether or not the relative forms of the components are similar between the two pieces of skeleton data to be compared. At this time, the motion detection unit 11 calculates a similarity between the two pieces of skeleton data. When calculating the similarity, the motion detection unit 11 can calculate the similarity using, for example, a feature amount calculated from the components included in the skeleton data.

In addition, the calculation target of the motion detection unit 11 may be, instead of the similarity, a similarity between a part of the extracted skeleton data and skeleton data related to the registered motion, a similarity between the extracted skeleton data and a part of the skeleton data related to the registered motion, or a similarity between a part of the extracted skeleton data and a part of the skeleton data related to the registered motion.

In addition, the motion detection unit 11 may calculate the similarity described above by directly using the skeleton data or indirectly using the skeleton data. For example, the motion detection unit 11 may convert at least a part of the skeleton data into another format and calculate the similarity described above using the converted data. In this case, the similarity may be the similarity itself between the converted pieces of data, or may be a value calculated using the similarity between the converted pieces of data.

The conversion method may be normalization of the image size according to the skeleton data, or may be conversion into a feature amount using an angle (that is, the degree of bending of the joint) formed by the skeleton structure. Alternatively, the conversion method may be a three-dimensional posture converted by a trained model of machine learning trained in advance.

With the above-described configuration, the motion detection unit 11 according to the present example embodiment detects the first motion and the second motion similar to the predetermined registered motion. Alternatively, the motion detection unit 11 detects a predetermined registered motion having the highest similarity to the detected first motion. Similarly, the motion detection unit 11 detects a predetermined registered motion having the highest similarity to the detected second motion.

Alternatively, the motion detection unit 11 calculates the similarity between the motion performed by the worker and the predetermined registered motion. The predetermined registered motion is, for example, information regarding a typical work motion performed by a person at a work site. When the detected motion is similar to the predetermined registered motion, the motion detection unit 11 supplies a signal indicating that the motion is similar to the registered motion to the appropriateness calculation unit 13. In this case, the motion detection unit 11 may supply information regarding a similar registered motion to the appropriateness calculation unit 13, or may supply a similarity for a similar registered motion.

In addition, as described above, the motion detection unit 11 according to the present example embodiment detects a motion from skeleton data regarding the structure of the body of a person extracted from image data regarding an image including the person. That is, the motion detection unit 11 extracts images of the bodies of the first worker P11 and the second worker P12 from the image data, and estimates each of the extracted simulated skeletons related to the structure of the body of the worker. In addition, in this case, the motion detection unit 11 detects the motion by comparing the skeleton data related to the motion with the skeleton data as the registered motion based on the forms of the elements forming the skeleton data.

In addition, the motion detection unit 11 may detect a posture or a motion from skeleton data extracted from one piece of image data. The motion detection unit 11 may detect a motion from posture changes extracted in time series from each of a plurality of pieces of image data captured at a plurality of different times. That is, the motion detection unit 11 detects posture changes of the first worker P11 and the second worker P12 from a plurality of frames. With such a configuration, the management apparatus 20 can flexibly analyze the motion in accordance with the change state of the posture or the motion to be detected. Also in this case, the motion detection unit 11 can use the registered motion database.

The correspondence specifying unit 12 according to the present example embodiment may use the skeleton data extracted by the motion detection unit 11. For example, the correspondence specifying unit 12 may specify the correspondence related to the position by comparing the predetermined positions of the skeleton data of the first worker P11 and the skeleton data of the second worker P12. In addition, the correspondence specifying unit 12 may specify a time-dependent correspondence between the first worker P11 and the second worker P12 from the posture change of the skeleton data.

The appropriateness calculation unit 13 according to the present example embodiment calculates the appropriateness with reference to predetermined correspondence data. The appropriateness calculation unit 13 reads the correspondence database included in the storage unit 210. The correspondence database includes a plurality of pieces of correspondence data. The correspondence data is data used in a case where calculating the appropriateness of the work performed by the worker, and includes data related to the motion of the worker and data related to the correspondence. That is, the appropriateness calculation unit 13 can also be said to calculate the appropriateness from the types of the first motion and the second motion and the correspondence detected by the correspondence specifying unit 12. That is, the appropriateness calculation unit 13 refers to the correspondence data corresponding to the type of the motion detected by the motion detection unit 11 or the combination of the motions of a plurality of workers. The appropriateness calculation unit 13 generates appropriateness information of the work performed by the worker with reference to the correspondence database. The output unit 14 according to the present example embodiment outputs the appropriateness information generated by the appropriateness calculation unit 13 to the display unit 202.

In the calculation of the appropriateness, the appropriateness calculation unit 13 evaluates, for example, the timing or positional relationship of the motion of the worker. When evaluating the timing of the motion, for example, the appropriateness calculation unit 13 may compare a difference in timing between predetermined motions with a reference value stored in advance. When evaluating the positional relationship of the motion, for example, the appropriateness calculation unit 13 may store the positional relationship of predetermined skeleton data as a rule and evaluate the positional relationship according to the stored rule. Alternatively, the appropriateness calculation unit 13 may have a query including a positional relationship of a plurality of pieces of skeleton data and compare similarity with the query. In addition, the appropriateness calculation unit 13 may use the above-described method depending on the situation.

The image data acquisition unit 201 is an interface that acquires image data supplied from the camera 100. The image data acquired by the image data acquisition unit 201 includes images captured by the camera 100 every predetermined period. The image data acquisition unit 201 supplies the acquired image data to, for example, the motion detection unit 11.

The display unit 202 is a display including a liquid crystal panel or organic electroluminescence. The display unit 202 displays the appropriateness information output from the output unit 14, and presents the appropriateness of the work performed by the worker to the user of the management apparatus 20.

The operation receiving unit 203 includes, for example, an information input means such as a keyboard and a touch pad, and receives an operation from the user who operates the management apparatus 20. The operation receiving unit 203 may be a touch panel superimposed on the display unit 202 and set to interlock with the display unit 202.

The storage unit 210 is a storage means including a non-volatile memory, such as a flash memory. The storage unit 210 stores at least a registered motion database and a correspondence database. The registered motion database includes skeleton data as a registered motion. The correspondence database includes a plurality of pieces of correspondence data. That is, the storage unit 210 stores at least correspondence data related to a correspondence between the first motion related to the first worker P11 and the second motion related to the second worker P12. The correspondence data includes a combination of the first motion and the second motion that can be detected, and information indicating at least one of a correspondence regarding the time of each motion and a correspondence regarding a position with respect to the combination. That is, the correspondence data may include a different correspondence for each content (combination of the first motion and the second motion) of the motion pattern.

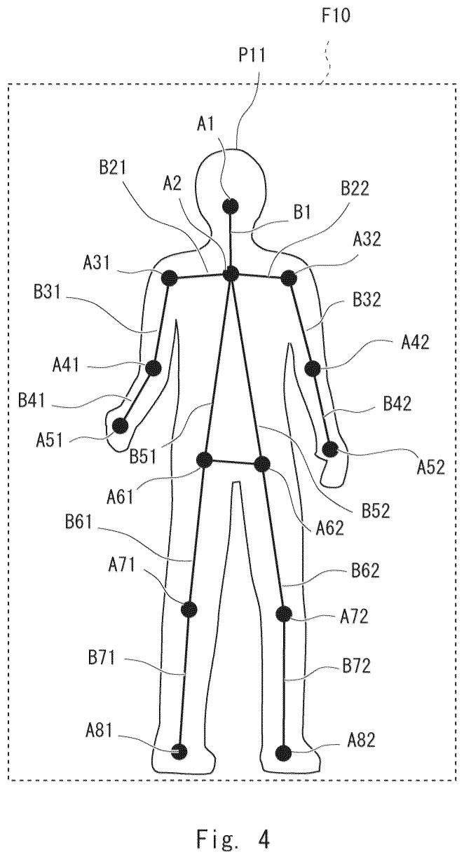

Next, an example of detecting the posture of a person will be described with reference to FIG. 4. FIG. 4 is a diagram illustrating skeleton data extracted from image data. The image illustrated in FIG. 4 is a body image F10 obtained by extracting the body of the first worker P11 from the image captured by the camera 100. In the management apparatus 20, the motion detection unit 11 cuts out the body image F10 from the image captured by the camera 100, and sets the skeleton structure.

The motion detection unit 11 extracts, for example, feature points that can be key points of the first worker P11 from the image. In addition, the motion detection unit 11 detects key points from the extracted feature points. When detecting key points, the motion detection unit 11 refers to, for example, information machine-learned about the image of key points.

In the example illustrated in FIG. 4, the motion detection unit 11 detects a head A1, a neck A2, a right shoulder A31, a left shoulder A32, a right elbow A41, a left elbow A42, a right hand A51, a left hand A52, a right waist A61, a left waist A62, a right knee A71, a left knee A72, a right foot A81, and a left foot A82 as key points of the first worker P11.

In addition, the motion detection unit 11 sets bones connecting these key points as a pseudo skeleton structure of the first worker P11 as follows. The bone B1 connects the head A1 and the neck A2 to each other. The bone B21 connects the neck A2 and the right shoulder A31 to each other, and the bone B22 connects the neck A2 and the left shoulder A32 to each other. The bone B31 connects the right shoulder A31 and the right elbow A41 to each other, and the bone B32 connects the left shoulder A32 and the left elbow A42 to each other. The bone B41 connects the right elbow A41 and the right hand A51 to each other, and the bone B42 connects the left elbow A42 and the left hand A52 to each other. The bone B51 connects the neck A2 and the right waist A61 to each other, and the bone B52 connects the neck A2 and the left waist A62 to each other. The bone B61 connects the right waist A61 and the right knee A71 to each other, and the bone B62 connects the left waist A62 and the left knee A72 to each other. Then, the bone B71 connects the right knee A71 and the right foot A81 to each other, and the bone B72 connects the left knee A72 and the left foot A82 to each other. When the skeleton data related to the skeleton structure is generated, the motion detection unit 11 compares the generated skeleton data with the registered motion.

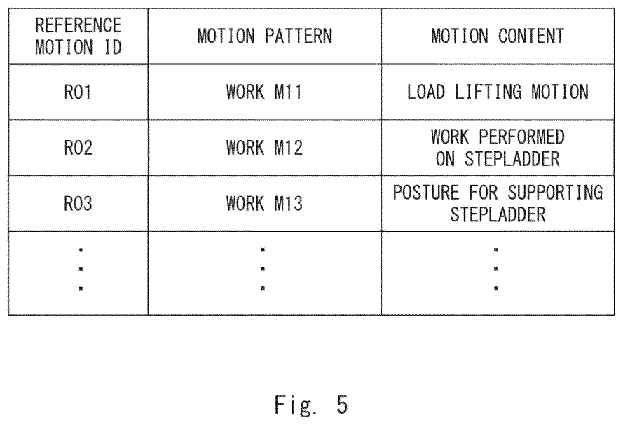

Next, an example of the registered motion database will be described with reference to FIG. 5. FIG. 5 is a diagram for explaining a registered motion database according to the second example embodiment. In the table illustrated in FIG. 5, a registered motion ID (identification, identifier) and a plurality of motion patterns are associated with each other. In addition, the motion content is illustrated next to the motion pattern for easy understanding. A motion pattern related to a motion whose registered motion ID (or motion ID) is “R01” is “work M11”. The motion content of the work “M11” is “load lifting motion”.

Similarly, the motion pattern having a registered motion ID “R02” is “work M12”, and the motion content is “work performed on a stepladder”. The motion pattern having a registered motion ID “R03” is “work M13”, and the motion content is “posture for supporting stepladder”. In addition, the registered motion database may have a motion pattern of an inappropriate motion in a predetermined work.

As described above, the data regarding the registered motion included in the registered motion database is stored so that the motion ID and the motion pattern are associated with each other for each motion. Each motion pattern is associated with one or more pieces of skeleton data. For example, the registered motion having a motion ID “R01” includes skeleton data indicating a motion of lifting a predetermined load.

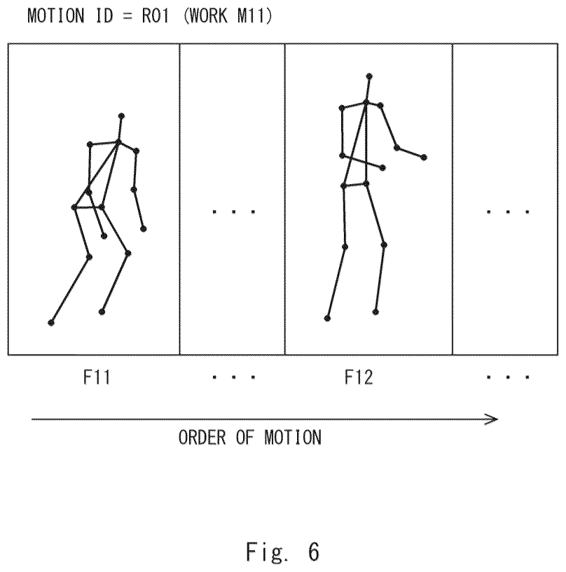

The skeleton data according to the registered motion will be described with reference to FIG. 6. FIG. 6 is a diagram for explaining a first example of the registered motion according to the second example embodiment. FIG. 6 illustrates skeleton data regarding a motion having a motion ID “R01” among the registered motions included in the registered motion database. FIG. 6 illustrates a plurality of pieces of skeleton data including skeleton data F11 and skeleton data F12 in a state of being arranged in the left-right direction. The skeleton data F11 is located on the left side of the skeleton data F12. The skeleton data F11 is a posture obtained by capturing a scene of a person performing a series of load lifting motions. The skeleton data F12 is a scene of a person performing a series of load lifting motions, and is a posture different from that of the skeleton data F11.

FIG. 6 means that, in the registered motion having a motion ID “R01”, the person takes a posture corresponding to the skeleton data F11 and then takes a posture of the skeleton data F12. In addition, although two pieces of skeleton data have been described herein, the registered motion having a motion ID “R01” may include skeleton data other than the above-described skeleton data.

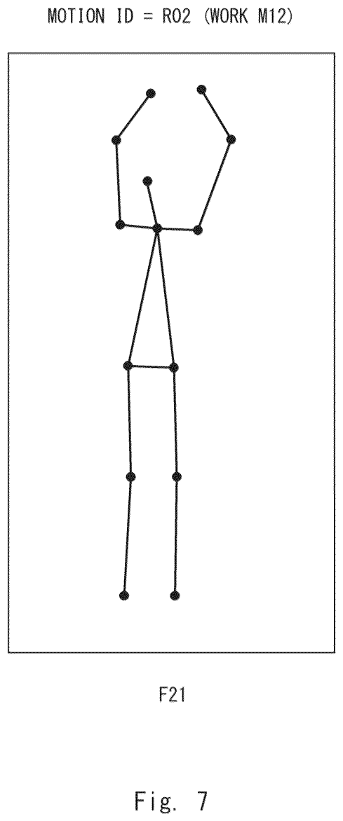

FIG. 7 is a diagram for explaining a second example of the registered motion according to the second example embodiment. FIG. 7 illustrates skeleton data F21 related to the motion having a motion ID “R02” illustrated in FIG. 5. In the registered motion having a motion ID “R02”, only one piece of skeleton data F21 indicating a person performing work on a stepladder at the work site is registered.

As described above, the registered motion included in the registered motion database may include only one piece of skeleton data or may include two or more pieces of skeleton data. The motion detection unit 11 determines whether or not there is a similar registered motion by comparing the registered motion including the above-described skeleton data with the skeleton data estimated from the image received from the image data acquisition unit 201.

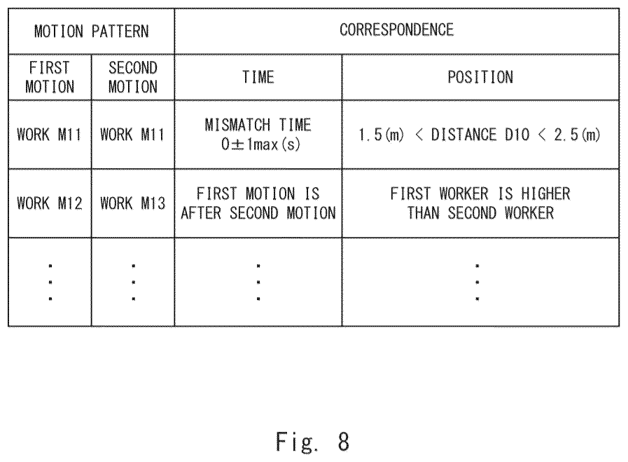

Next, a correspondence database will be described with reference to FIG. 8. FIG. 8 is a diagram for explaining a correspondence database according to the second example embodiment. The table illustrated in FIG. 8 illustrates a correspondence database, and “motion pattern” and “correspondence” are arranged in the left-right direction. The “motion pattern” includes “first motion” and “second motion”. The “correspondence” includes “time” and “position”. In addition, symbols described in the table illustrated in FIG. 8 correspond to the contents of FIG. 5.

In the first row of this table, “work M11” is illustrated for the first motion, and “work M11” is also illustrated for the second motion. In addition, in the same row, “mismatch time 0±1 max(s)” is illustrated as a time-dependent correspondence. This indicates that for the movements of the first motion and the second motion, the time mismatch is at most zero plus or minus one second. That is, here, this means that it is preferable that the first motion and the second motion are basically synchronous. In the same row, “1.5 (m)<distance D10<2.5 (m)” is illustrated for the distance D10 as a correspondence related to the position. This indicates that it is a preferable correspondence that the first worker P11 and the second worker P12 who perform a load lifting motion in cooperation perform work at a distance of more than 1.5 meters, which is a first threshold value, and less than 2.5 meters, which is a second threshold value.

That is, the first row indicates that the first worker P11 and the second worker P12 perform the work M11 together, that these motions are basically synchronous, and that the distance D10 between the first worker P11 and the second worker P12 is 1.5 to 2.5 meters. The appropriateness calculation unit 13 selects the above-described correspondence data from the motions detected from the first worker P11 and the second worker P12 according to the image captured by the camera, and compares the correspondence data with the correspondence included in the selected correspondence data. Then, the appropriateness calculation unit 13 calculates the appropriateness from the degree of matching or the degree of mismatch detected as a result of the comparison.

Similarly, in the second row of the table illustrated in FIG. 8, the first motion is illustrated as “work M12”, the second motion is illustrated as “work M13”, the time-dependent correspondence is illustrated as “the first motion is after the second motion”, and the position-dependent correspondence is illustrated as “the first worker is higher than the second worker”. This indicates that in a case where the first worker P11 performs “work on a stepladder” as the work M12, the second worker P12 takes a “posture for supporting the stepladder” as the work M13.

In this case, it is illustrated that the first work performed by the first worker P11 is detected after the second work. In addition, it is illustrated that the position of the first worker P11 who works on the stepladder is higher than the position of the second worker P12 who supports the stepladder. The appropriateness calculation unit 13 calculates the appropriateness by comparing the motions detected from the first worker P11 and the second worker P12 related to the image captured by the camera with the correspondence data.

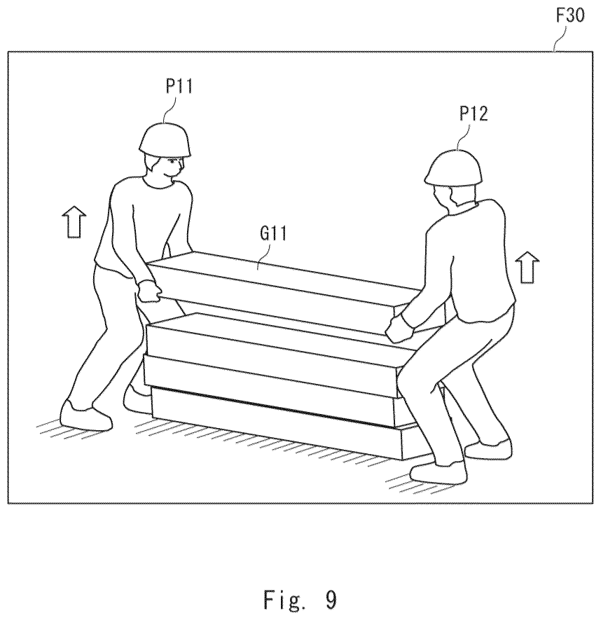

Next, the above-described correspondence will be described with reference to a specific image example. FIG. 9 is a diagram illustrating a first example of an image captured by a camera. An image F30 illustrated in FIG. 9 is an image captured by the camera 100, and includes a first worker P11, a second worker P12, and a load G11. The image F30 illustrates a scene of work of lifting the load G11 while the first worker P11 and the second worker P12 cooperate with each other. Here, in the work performed by the first worker P11 and the second worker P12, it is set to be appropriate to lift the load G11 while matching the motions so that the load G is not tilted.

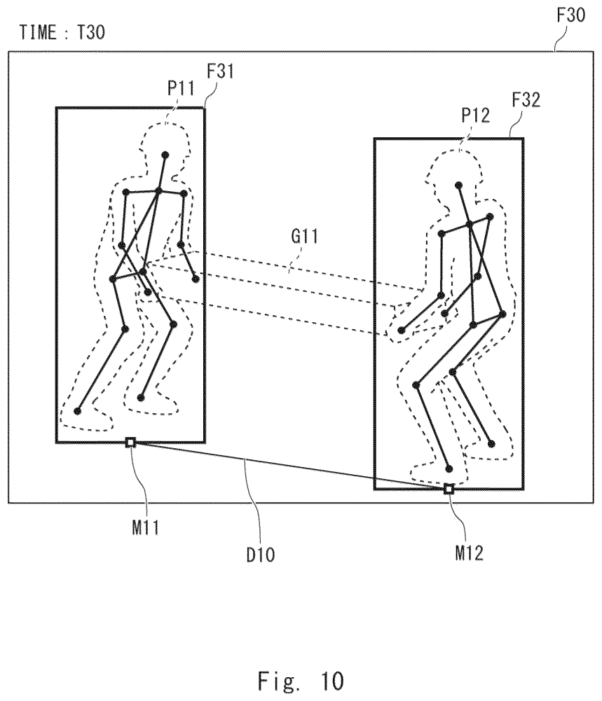

FIG. 10 is a first diagram illustrating skeleton data extracted by the management apparatus. An image F30 illustrated in FIG. 10 is extracted from the image F30 illustrated in FIG. 9 by the motion detection unit 11, and includes a first image F31 and a second image F32. The first image F31 includes a body image and skeleton data of the first worker P11. The second image F32 includes a body image and skeleton data of the second worker P12.

For the image F30 in FIG. 10, the correspondence specifying unit 12 detects a correspondence according to the position between the first worker P11 in the first image F31 and the second worker P12 in the second image F32. Here, the correspondence specifying unit 12 further specifies the first point M11 at the lower center of the first image F31 and the second point M12 at the lower center of the second image F32, and then measures the distance D10 between the first point M11 and the second point M12.

For the image F30 in FIG. 10, the correspondence specifying unit 12 records a relationship between the motion and the time of the first image F31. Similarly, the correspondence specifying unit 12 records a relationship between the motion and the time of the second image F32. In the image F30 illustrated in FIG. 10, a time T30 is illustrated at the upper left. The correspondence specifying unit 12 records the state of each motion at the time T30. Alternatively, the correspondence specifying unit 12 may detect a difference between these motions by comparing the states of the respective motions at the time T30.

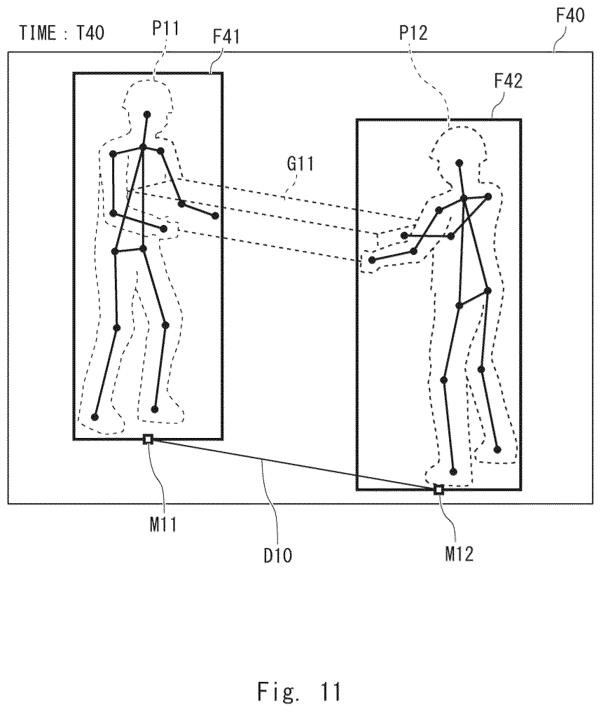

FIG. 11 is a second diagram illustrating skeleton data extracted by the management apparatus. An image F40 illustrated in FIG. 11 includes a first image F41 and a second image F42 extracted from the image at time T30 after time T40 of the image F30 illustrated in FIG. 10. The first image F41 includes a body image and skeleton data of the first worker P11. The second image F42 includes a body image and skeleton data of the second worker P12. The image illustrated in FIG. 11 indicates that the first worker P11 and the second worker P12 simultaneously lift both ends of the load G11 at a time T40 after the time T30.

As illustrated in FIGS. 9 to 11, the motion detection unit 11 detects the motions of the first worker P11 and the second worker P12. Then, the correspondence specifying unit 12 detects or measures the correspondence between the first motion of the first worker P11 and the second motion of the second worker P12. Then, the appropriateness calculation unit 13 compares these pieces of information detected or measured from FIGS. 10 and 11 with the correspondence database illustrated in FIG. 8, and calculates the appropriateness from the degree of matching or the degree of mismatch detected as a result of the comparison.

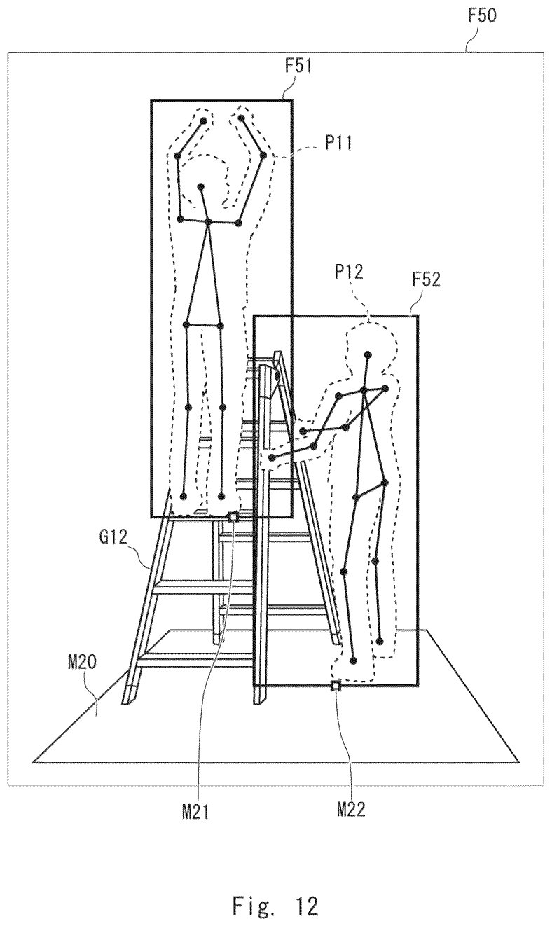

Next, a further example of functions implemented by the management apparatus 20 will be described with reference to FIG. 12. FIG. 12 is a diagram in which skeleton data is superimposed on a second example of an image captured by a camera. An image 50 illustrated in FIG. 12 is an image captured by the camera 100, and illustrates a situation in which the first worker P11 performs predetermined work on the stepladder G12 and the second worker P12 supports the stepladder G12. In the image F50, a first image F51 and a second image F52 are superimposed on the image captured by the camera 100. The first image F51 includes a body image and skeleton data of the first worker P11. In the first image F51, the first worker P11 performs the work M12 (work performed on the stepladder) illustrated in FIG. 5. The second image F52 includes a body image and skeleton data of the second worker P12. In the second image F52, the second worker P12 takes the work M13 (posture for supporting the stepladder) illustrated in FIG. 5.

In the above-described situation, the correspondence specifying unit 12 compares the image F50 with the correspondence database illustrated in FIG. 8. The image F50 corresponds to the example of the second row of the correspondence database illustrated in FIG. 8. That is, the motion detection unit 11 detects the work M12 in the first image F51 as a first motion, and detects the work M13 in the second image F52 as a second motion. The correspondence specifying unit 12 determines whether or not the second motion related to the second worker P12 is detected at the time before the first motion related to the first worker P11 is detected from the image at the time before the image F50 illustrated in FIG. 12.

The correspondence specifying unit 12 measures a positional relationship between the first worker P11 related to the first motion and the second worker P12 related to the second motion. For example, the correspondence specifying unit 12 can measure the difference between the height of the first worker P11 and the height of the second worker P12 by comparing the first point M21 illustrated at the lower center of the first image F51 with the second point M22 illustrated at the lower center of the second image F52. In addition, the correspondence specifying unit 12 may set a predetermined plane M20 in the image F50 and measure the position or height of the worker with the set plane M20 as a reference. In addition, the first point M21 and the second point M22 described above are merely examples, and the method of comparing the positional relationship between the workers is not limited to the content described above. The correspondence specifying unit 12 may set, for example, an upper portion, a central portion, or the like of the body image instead of the central lower portion of the body image of the worker, or may set a position corresponding to a predetermined portion of the body such as the head or the waist.

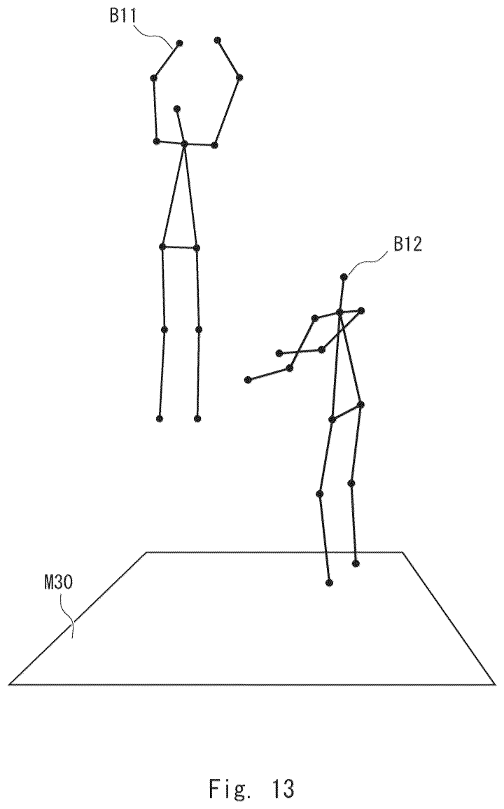

Next, a further example of the correspondence database will be described with reference to FIG. 13. FIG. 13 is a diagram for explaining an example of a rule of a positional relationship in correspondence data. FIG. 13 illustrates an arrangement of elements corresponding to a pseudo three-dimensional space set in advance. FIG. 13 includes a reference plane M30, first skeleton data B11, and second skeleton data B12. The reference plane M30 is a floor surface set in a pseudo manner that can correspond to the plane M20 in FIG. 12. The first skeleton data B11 is skeleton data located above the reference plane M30 so as to be spaced apart therefrom. The first skeleton data B11 takes a posture corresponding to the work M12 (work performed on a stepladder) illustrated in FIG. 5. The second skeleton data B12 is skeleton data grounded above the reference plane M30. The second skeleton data B12 takes a posture corresponding to the work M13 (posture for supporting a stepladder) illustrated in FIG. 5.

FIG. 13 illustrates an aspect of the data of the correspondence regarding the position in the correspondence data, and illustrates the correspondence regarding the position in the correspondence illustrated in the second row of the correspondence database illustrated in FIG. 8. That is, the correspondence specifying unit 12 compares the data in FIG. 13 with the skeleton data specified from the image (for example, the image F50 in FIG. 12) captured by the camera. As described above, the rule of the correspondence in the correspondence database is not limited to the rule of the text as illustrated in FIG. 8, and may be set by arrangement of elements indicating the motion illustrated in FIG. 13. In addition, although FIG. 13 is set for a predetermined positional relationship, the positional relationship illustrated in FIG. 13 may include a posture changing in time series.

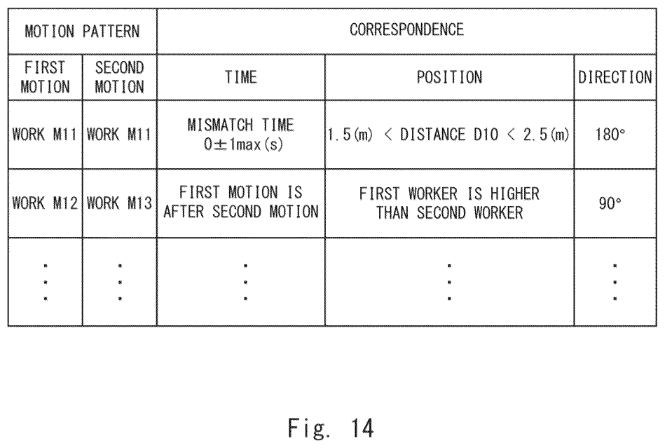

Next, a further example of the correspondence database will be described with reference to FIG. 14. FIG. 14 is a diagram for explaining a second example of the correspondence database. The table illustrated in FIG. 14 is different from the correspondence database illustrated in FIG. 8 in that the correspondence includes “direction”. The correspondence specifying unit 12 recognizes the orientation of the body of the worker from the skeleton data generated by the motion detection unit 11. That is, “direction” illustrated in FIG. 14 indicates a correspondence relation related to the orientation of the body of the person. That is, for example, in a case where the first worker P11 and the second worker P12 face the same direction, the angle is 0°, and in a case where they face each other, the angle is 180°. In addition, for example, the above-described 0° may be substantially 0°, and include an allowable range of about +10°, for example.

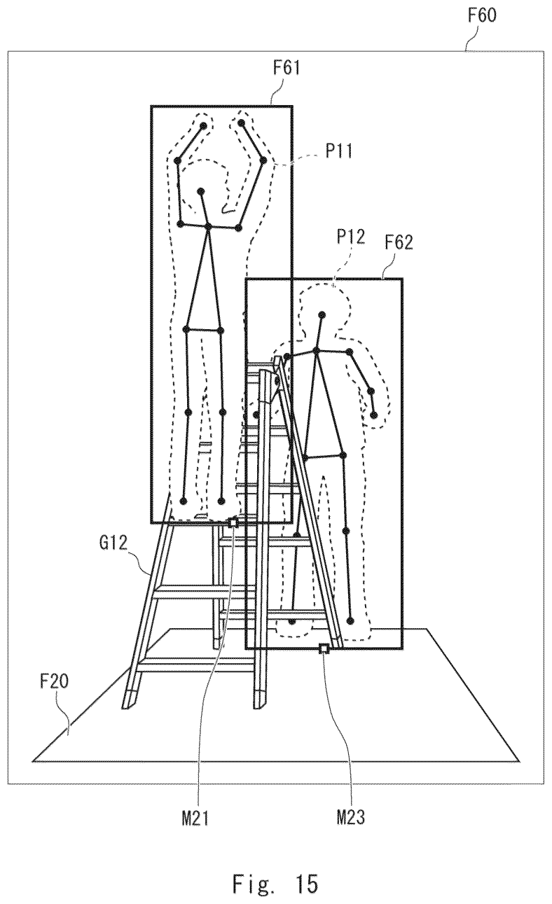

FIG. 15 is a diagram illustrating an image according to a second example of the correspondence database. In an image F60 illustrated in FIG. 15, a second worker P12 stands in front of a second worker P12. Therefore, the correspondence according to the direction between the first worker P11 and the second worker P12 in the image F60 is 180°.

On the other hand, in the correspondence database illustrated in FIG. 14, according to the correspondence data illustrated in the second row, the positional relationship according to the direction is “90°”. That is, in a case where the first worker P11 is performing the work M12 on the stepladder G12, it is set in the correspondence database that it is appropriate for the second worker P12 to support the stepladder G12 from the side surface of the first worker P11. Therefore, the appropriateness calculation unit 13 calculates the appropriateness of the work related to the image F60 to be lower than the appropriateness of the work related to the image F50 illustrated in FIG. 12. Alternatively, the appropriateness calculation unit 13 generates appropriateness information for determining that the work related to the image F60 is not appropriate.

Although the second example embodiment has been described above, the configuration of the management apparatus 20 according to the second example embodiment is not limited to the above contents. The content of the correspondence database illustrated in FIG. 8 or 14 is an example, and the items related to the correspondence may include items that can be conceived by those skilled in the art in addition to the time, the position, and the direction. The number of workers may be three or more as long as the number of workers is plural.

The number of cameras 100 included in the management system 2 is not limited to one, and may be plural. The camera 100 may have some functions of the motion detection unit 11. In this case, for example, the camera 100 may extract the body image related to the person by processing the captured image. Alternatively, the camera 100 may further extract skeleton data of at least a part of the body of the person from the body image based on the characteristics of joints and the like of the person recognized in the body image.

The management apparatus 20 and the camera 100 may directly communicate with each other without the network N1. The management apparatus 20 may include the camera 100. That is, the management system 2 may have the same meaning as the management apparatus 20.

Up to now, the second example embodiment has been described. In addition, the appropriateness calculation unit 13 can adopt various methods in calculating the appropriateness. For example, the appropriateness calculation unit 13 may detect a predetermined first motion and may not detect a second motion corresponding to the first motion. In such a case, the appropriateness calculation unit 13 may calculate the appropriateness in the above-described case to be lower than the appropriateness in a case where both the first motion and the second motion are detected.

In addition, the appropriateness calculation unit 13 may detect both the first motion and the second motion and detect that the positional relationship between the first motion and the second motion does not satisfy predetermined conditions. In such a case, the appropriateness calculation unit 13 may calculate the appropriateness described above to be lower than the appropriateness in a case where both the first motion and the second motion are detected and the positional relationship between the first motion and the second motion satisfies predetermined conditions.

The appropriateness calculation unit 13 may detect both the first motion and the second motion and detect that the relationship in time series between the first motion and the second motion does not satisfy predetermined conditions. In such a case, the appropriateness calculation unit 13 may calculate the appropriateness described above to be lower than the appropriateness in a case where both the first motion and the second motion are detected and the relationship in time series between the first motion and the second motion satisfies predetermined conditions.

The number of workers included in the image captured by the camera 100 is not limited to two, and may be three or more. In this case, the management apparatus 20 may calculate the appropriateness for the correspondence between at least two workers among the workers included in the image. As described above, according to the second example embodiment, it is possible to provide a management system and the like that can efficiently and easily manage the appropriateness of work performed by a plurality of workers in cooperation.

### Third Example Embodiment

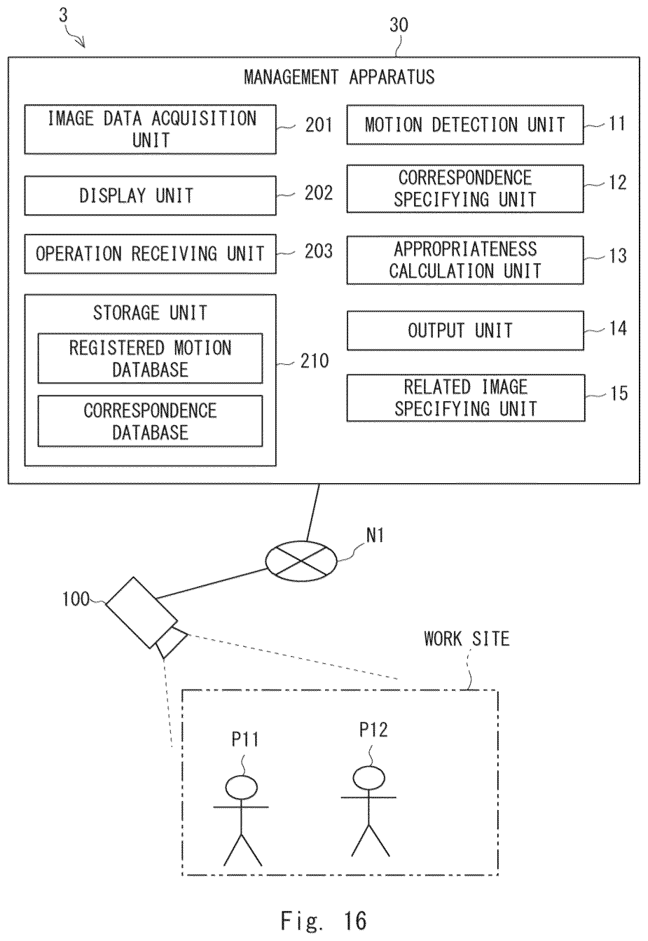

Next, a third example embodiment will be described. FIG. 16 is a diagram illustrating the overall configuration of a management system 3 according to the third example embodiment. The management system 3 according to the third example embodiment includes a management apparatus 30 and a camera 100. The management apparatus 30 is different from the management apparatus 20 according to the second example embodiment in that the management apparatus 30 includes a related image specifying unit 15.

The related image specifying unit 15 specifies a related image indicating a predetermined object or area related to the work from the image data. The predetermined related image is set in advance, and may include, for example, a load carried by the worker or a tool used by the worker. In addition, the predetermined related image may be an image related to the facility, the passage, and the preset area used by the worker.

The related image specifying unit 15 may specify a related image by recognizing the above-described image from the image captured by the camera. For example, the related image specifying unit 15 may detect a related image by performing predetermined convolution processing on image data including a predetermined object together with a known method such as histograms of oriented gradients (HOG) or machine learning. In addition, the related image specifying unit 15 may specify a predefined area superimposed on the image captured by the camera.

In this case, the correspondence specifying unit 12 specifies a positional relationship between the first motion and the second motion and the related image. In addition, the correspondence specifying unit 12 can specify a positional relationship between the worker and the related image according to the first motion and the second motion over time. As a result, the appropriateness calculation unit 13 can calculate the appropriateness in consideration of the related image.

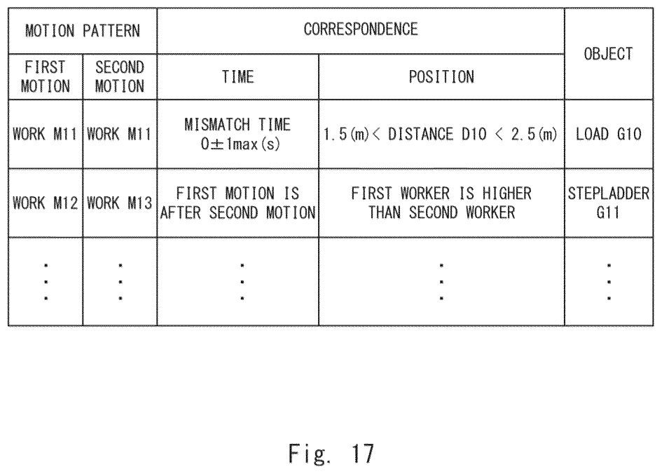

FIG. 17 is a diagram illustrating an example of a correspondence database according to the third example embodiment. The table of the correspondence database illustrated in FIG. 17 is different from the correspondence database illustrated in FIG. 8 in that an item related to an object is added. In the table of FIG. 17, an object in the first row is “load G10”. In the table of FIG. 17, an object in the second row is “stepladder G11”.

For example, in the example illustrated in FIG. 9, the related image specifying unit 15 detects the load G11. Therefore, the management apparatus 30 may set an appropriate positional relationship between the worker carrying the load G11 and the load G1. Similarly, in the example illustrated in FIG. 12 or 15, the related image specifying unit 15 may detect a stepladder. Therefore, the management apparatus 30 can recognize the positional relationship between the stepladder and the worker in more detail. As a result, the management apparatus 30 can calculate the appropriateness of the work more appropriately.

With the configuration described above, according to the third example embodiment, it is possible to provide a management system and the like that can efficiently and easily manage the appropriateness of work performed by a plurality of workers in cooperation.

### Fourth Example Embodiment

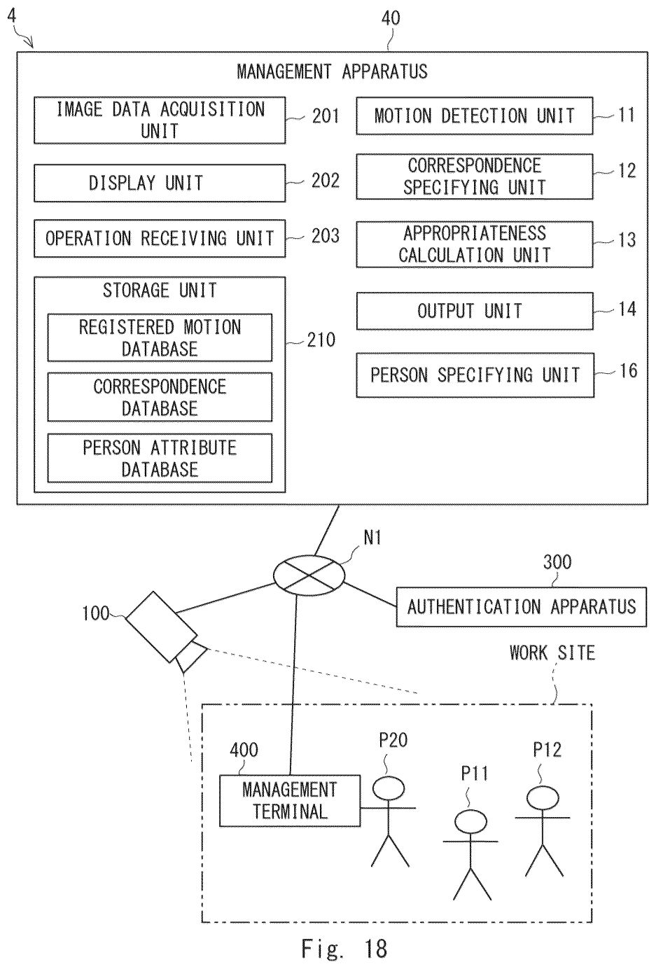

Next, a fourth example embodiment will be described with reference to FIG. 18. FIG. 18 is a diagram illustrating the overall configuration of a management system 4 according to the fourth example embodiment. The management system 3 illustrated in FIG. 18 includes a management apparatus 40, a camera 100, an authentication apparatus 300, and a management terminal 400. These components are communicably connected to each other through the network N1. That is, the management system 4 according to the present example embodiment is different from that in the second example embodiment in that the management apparatus 40 is provided instead of the management apparatus 20 and the authentication apparatus 300 and the management terminal 400 are provided.

The management apparatus 40 specifies a predetermined person in cooperation with the authentication apparatus 300, calculates the appropriateness of the work performed by the specified person, and outputs the determination result to the management terminal 400. The management apparatus 40 is different from the management apparatus 20 according to the second example embodiment in that the management apparatus 40 includes a person specifying unit 16. In addition, the storage unit 210 included in the management apparatus 40 is different from that in the management apparatus 20 according to the second example embodiment in that a person attribute database related to a specified person is stored.

The person specifying unit 16 specifies a person included in the image data. The person specifying unit 16 specifies a person included in the image captured by the camera 100 by associating the authentication data of the person authenticated by the authentication apparatus 300 with the attribute data stored in the person attribute database.

In this case, the output unit 14 outputs the appropriateness of the work related to the specified person to the management terminal 400. Then, in a case where the work performed by the specified person is not appropriate, a warning signal corresponding to the specified person is output to the management terminal 400. That is, the output unit 14 according to the present example embodiment outputs a predetermined warning signal in a case where it is determined that the work performed by the worker is not appropriate.

In addition, the appropriateness calculation unit 13 may have a plurality of levels of appropriateness for determining whether or not the work is appropriate. In this case, the output unit 14 outputs a warning signal corresponding to the level. With such a configuration, the management apparatus 40 can manage the work more flexibly.

The person attribute database stored in the storage unit 210 includes attribute data of the specified person. The attribute data includes a name of a person, a unique identifier, and the like. The attribute data may include data related to the work of the person. That is, the attribute data can include, for example, a group to which the person belongs, a type of work performed by the person, and the like. In addition, the attribute data may include, for example, the age, gender, and the like of the person as data related to the appropriateness of the work.

The motion detection unit 11, the related image specifying unit 15, and the appropriateness calculation unit 13 according to the present example embodiment may perform determination according to the attribute data of the person. That is, for example, the motion detection unit 11 may compare the registered motion corresponding to the specified person. The related image specifying unit 15 may recognize a related image corresponding to the specified person. In addition, the appropriateness calculation unit 13 may make the determination by referring to the correspondence data corresponding to the specified person. With such a configuration, the management apparatus 40 can manage the work customized for the specified person.

The authentication apparatus 300 is a computer or a server apparatus including one or a plurality of arithmetic apparatuses. The authentication apparatus 300 authenticates a person present at the work site from the image captured by the camera 100, and supplies a result of the authentication to the management apparatus 30. When the authentication of the person is successful, the authentication apparatus 300 supplies authentication data associated with the person attribute data stored in the management apparatus 30 to the management apparatus 30.

The management terminal 400 is a tablet terminal, a smartphone, a dedicated terminal apparatus having a display device, or the like, and can receive appropriateness information generated by the management apparatus 30 and present the received appropriateness information to a manager P20. By recognizing the appropriateness information presented to the management terminal 400 at the work site, the manager P20 can know the work situation of the first worker P11 and the second worker P12 who are workers.

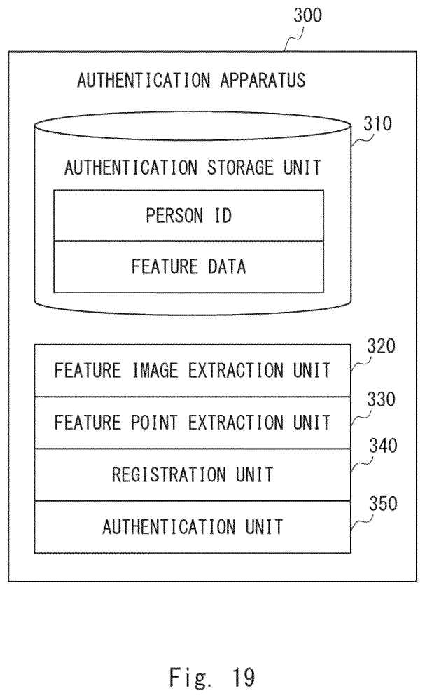

Next, the configuration of the authentication apparatus 300 will be described in detail with reference to FIG. 19. FIG. 19 is a block diagram of the authentication apparatus 300. The authentication apparatus 300 authenticates a person by extracting a predetermined feature image from the image captured by the camera 100. The feature image is, for example, a facial image. The authentication apparatus 300 includes an authentication storage unit 310, a feature image extraction unit 320, a feature point extraction unit 330, a registration unit 340, and an authentication unit 350.

The authentication storage unit 310 stores a person ID and feature data of the person in association with each other. The feature image extraction unit 320 detects a feature area included in the image acquired from the camera 100 and outputs the feature area to the feature point extraction unit 330. The feature point extraction unit 330 extracts a feature point from the feature area detected by the feature image extraction unit 320, and outputs data regarding the feature point to the registration unit 340. The face feature information is a set of extracted feature points.

The registration unit 340 newly issues a person ID when registering the feature data. The registration unit 340 registers the issued person ID and the feature data extracted from the registered image in the authentication storage unit 310 in association with each other. The authentication unit 350 compares the feature data extracted from the feature image with the feature data in the authentication storage unit 310. The authentication unit 350 determines that the authentication is successful in a case where the pieces of feature data match each other, and determines that the authentication has failed in a case where the pieces of feature data do not match each other. The authentication unit 350 notifies the management apparatus 30 of success or failure of the authentication. When the authentication is successful, the authentication unit 350 specifies the person ID associated with the successful feature data and notifies the management apparatus 30 of the authentication result including the specified person ID.

In addition, the authentication apparatus 300 may perform authentication of a person using a means different from the camera 100. The authentication may be biometric authentication or authentication using a mobile terminal, an IC card, or the like.

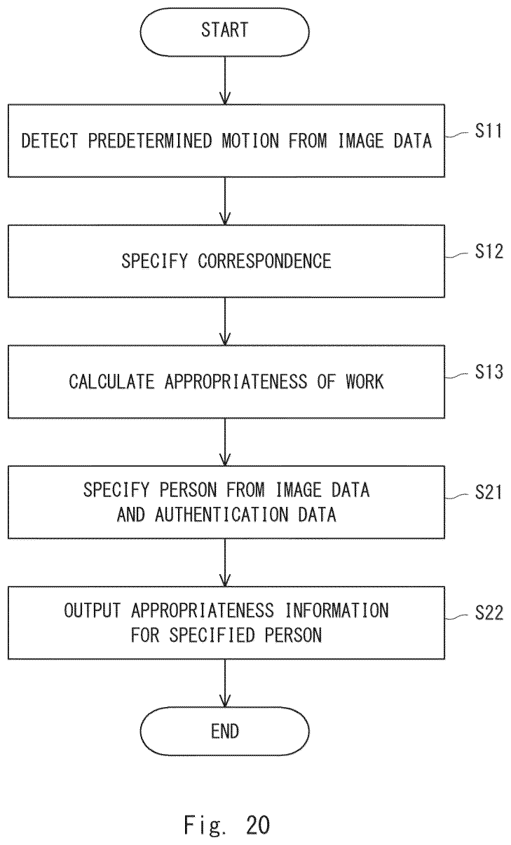

Processing performed by the management apparatus 30 according to the present example embodiment will be described with reference to FIG. 20. FIG. 20 is a flowchart illustrating a management method according to the fourth example embodiment. The flowchart illustrated in FIG. 20 is different from the flowchart illustrated in FIG. 2 in processing after step S13.

After step S13, the person specifying unit 16 specifies a person related to the appropriateness information from the image data and the authentication data (step S21). Then, the output unit 14 outputs appropriateness information for the specified person to the management terminal 400 (step S22). When the appropriateness information is output to the management terminal 400, the management apparatus 30 ends a series of processes.

In addition, the method executed by the management apparatus 30 is not limited to the method illustrated in FIG. 20. The management apparatus 30 may execute step S21 before step S13. In addition, the processing from step S11 to step S13 may correspond to the person specified as described above.

With the configuration described above, according to the fourth example embodiment, it is possible to provide a management apparatus and the like that can efficiently and easily manage the appropriateness of work performed by a plurality of workers in cooperation.

### <Example of Hardware Configuration>

Hereinafter, a case where each functional component of the determination apparatus in the present disclosure is implemented by a combination of hardware and software will be described.

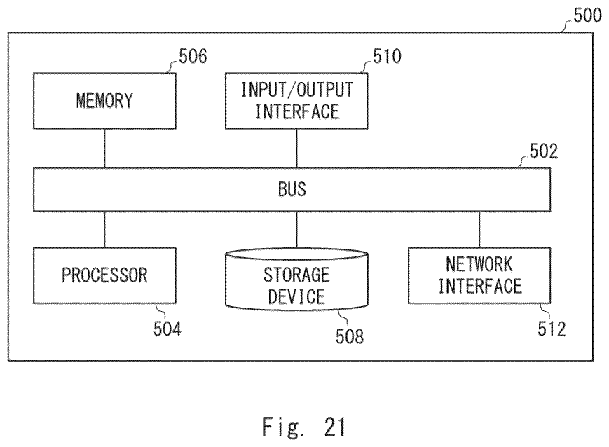

FIG. 21 is a block diagram illustrating the hardware configuration of a computer. A management apparatus in the present disclosure can implement the above-described functions using a computer 500 having the hardware configuration illustrated in the diagram. The computer 500 may be a portable computer such as a smartphone or a tablet terminal, or may be a stationary computer such as a PC. The computer 500 may be a dedicated computer designed to implement each apparatus, or may be a general-purpose computer. The computer 500 can implement a desired function by installing a predetermined program.

The computer 500 includes a bus 502, a processor 504, a memory 506, a storage device 508, an input/output interface 510 (an interface is also referred to as an I/F (interface)), and a network interface 512. The bus 502 is a data transmission path for the processor 504, the memory 506, the storage device 508, the input/output interface 510, and the network interface 512 to transmit and receive data to and from each other. However, a method of connecting the processor 504 and the like to each other is not limited to the bus connection.

The processor 504 is various processors such as a CPU, a GPU, or an FPGA. The memory 506 is a main storage device implemented by using a random access memory (RAM) or the like.

The storage device 508 is an auxiliary storage device implemented by using a hard disk, an SSD, a memory card, a read only memory (ROM), or the like. The storage device 508 stores a program for implementing a desired function. The processor 504 reads the program to the memory 506 and executes the program to implement each functional component of each apparatus.

The input/output interface 510 is an interface for connecting the computer 500 and an input/output apparatus to each other. For example, an input apparatus such as a keyboard and an output apparatus such as a display device are connected to the input/output interface 510.

The network interface 512 is an interface for connecting the computer 500 to a network.

Although the example of the hardware configuration in the present disclosure has been described above, the above-described example embodiment is not limited thereto. The present disclosure can also be implemented by causing a processor to execute a computer program.

In the above-described example, the program includes a group of instructions (or software code) for causing a computer to perform one or more functions described in the example embodiments when being read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. As an example and not by way of limitation, transitory computer-readable or communication media include electrical, optical, acoustic, or other forms of propagated signals.

Although the invention of the present application has been described above with reference to the example embodiments, the invention of the present application is not limited to the above. Various modifications that can be understood by those skilled in the art can be made to the configuration and details of the invention of the present application within the scope of the invention.

Some or all of the above example embodiments may be described as the following supplementary notes, but are not limited to the following.

### (Supplementary Note 1)

A management apparatus including:
a motion detection means for detecting a first motion performed by a first worker and a second motion performed by a second worker different from the first worker, the first and second workers being included in an image obtained by capturing a plurality of workers at a place where predetermined work is performed;
a correspondence specifying means for specifying a correspondence including at least one of a time and a position of the first motion and the second motion;
an appropriateness calculation means for calculating an appropriateness of the work based on the correspondence; and
an output means for outputting appropriateness information regarding the appropriateness.

### (Supplementary Note 2)

The management apparatus according to Supplementary Note 1, wherein the motion detection means detects the first motion and the second motion similar to a predetermined registered motion.

### (Supplementary Note 3)

The management apparatus according to Supplementary Note 2, wherein the motion detection means detects the first motion and the second motion from skeleton data regarding a structure of a body of the worker extracted from an image including the worker.

### (Supplementary Note 4)

The management apparatus according to Supplementary Note 3, wherein the motion detection means detects the first motion and the second motion by comparing the skeleton data related to a motion of the worker with the skeleton data as the registered motion based on a form of each element forming the skeleton data.

### (Supplementary Note 5)

The management apparatus according to any one of Supplementary Notes 2 to 4, wherein
the motion detection means detects a type of a motion performed by the worker based on the registered motion, and
the appropriateness calculation means calculates the appropriateness based on types of the first motion and the second motion and the correspondence.

### (Supplementary Note 6)

The management apparatus according to any one of Supplementary Notes 1 to 5, wherein the motion detection means detects the first motion and the second motion from a posture change extracted in time series from each of a plurality of images captured at a plurality of different times.

### (Supplementary Note 7)

The management apparatus according to any one of Supplementary Notes 1 to 6, further including: a storage means for storing correspondence data related to the correspondence between the first motion and the second motion,

wherein the appropriateness calculation means calculates the appropriateness with reference to the correspondence data.

### (Supplementary Note 8)

The management apparatus according to any one of Supplementary Notes 1 to 7, wherein the appropriateness calculation means calculates the appropriateness in a case where the predetermined first motion is detected and the second motion corresponding to the first motion is not detected to be lower than the appropriateness in a case where both the first motion and the second motion are detected.

### (Supplementary Note 9)

The management apparatus according to any one of Supplementary Notes 1 to 7, wherein

the appropriateness calculation means calculates the appropriateness in a case where both the first motion and the second motion are detected and a positional relationship between the first motion and the second motion does not satisfy predetermined conditions to be lower than the appropriateness in a case where both the first motion and the second motion are detected and the positional relationship between the first motion and the second motion satisfies the predetermined conditions.

### (Supplementary Note 10)

The management apparatus according to any one of Supplementary Notes 1 to 7, wherein the appropriateness calculation means calculates the appropriateness in a case where both the first motion and the second motion are detected and a relationship in time series between the first motion and the second motion does not satisfy predetermined conditions to be lower than the appropriateness in a case where both the first motion and the second motion are detected and the relationship in time series between the first motion and the second motion satisfies the predetermined conditions.

### (Supplementary Note 11)

The management apparatus according to any one of Supplementary Notes 1 to 10, further including: a related image specifying means for specifying a related image showing a predetermined object or area related to the work,

wherein the correspondence specifying means specifies a positional relationship between the first motion and the second motion and the related image.

### (Supplementary Note 12)

The management apparatus according to any one of Supplementary Notes 1 to 11, wherein the output means outputs a predetermined warning signal in a case where the appropriateness is lower than a predetermined threshold value.

### (Supplementary Note 13)

The management apparatus according to Supplementary Note 12, wherein the output means has a plurality of warning signals corresponding to the appropriateness and outputs a warning signal corresponding to the appropriateness.

### (Supplementary Note 14)

The management apparatus according to Supplementary Note 12 or 13, further including: a person specifying means for specifying a person who is the worker included in the image,

wherein the output means outputs the warning signal corresponding to the worker with the low appropriateness in a case where the appropriateness is lower than the predetermined threshold value.

### (Supplementary Note 15)

A management method
causing a computer to execute:
detecting a first motion performed by a first worker and a second motion performed by a second worker different from the first worker, the first and second workers being included in an image obtained by capturing a plurality of workers at a place where predetermined work is performed;
specifying a correspondence including at least one of a time and a position of the first motion and the second motion;
calculating an appropriateness of the work based on the correspondence; and
outputting appropriateness information regarding the calculated appropriateness.

### (Supplementary Note 16)

A non-transitory computer-readable medium storing a program for causing a computer to execute a management method including:
detecting a first motion performed by a first worker and a second motion performed by a second worker different from the first worker, the first and second workers being included in an image obtained by capturing a plurality of workers at a place where predetermined work is performed;
specifying a correspondence including at least one of a time and a position of the first motion and the second motion;
calculating an appropriateness of the work based on the correspondence; and
outputting appropriateness information regarding the calculated appropriateness.

### REFERENCE SIGNS LIST

2 MANAGEMENT SYSTEM
3 MANAGEMENT SYSTEM
10 MANAGEMENT APPARATUS
11 MOTION DETECTION UNIT
12 CORRESPONDENCE SPECIFYING UNIT
13 APPROPRIATENESS CALCULATION UNIT
14 OUTPUT UNIT
15 RELATED IMAGE SPECIFYING UNIT
16 PERSON SPECIFYING UNIT
20 MANAGEMENT APPARATUS
30 MANAGEMENT APPARATUS
100 CAMERA
201 IMAGE DATA ACQUISITION UNIT
202 DISPLAY UNIT
203 OPERATION RECEIVING UNIT
210 STORAGE UNIT
300 AUTHENTICATION APPARATUS
310 AUTHENTICATION STORAGE UNIT
320 FEATURE IMAGE EXTRACTION UNIT
330 FEATURE POINT EXTRACTION UNIT
340 REGISTRATION UNIT
350 AUTHENTICATION UNIT
400 MANAGEMENT TERMINAL
500 COMPUTER
504 PROCESSOR
506 MEMORY
508 STORAGE DEVICE
510 INPUT/OUTPUT INTERFACE
512 NETWORK INTERFACE
N1 NETWORK
P11 FIRST WORKER
P12 SECOND WORKER

What is claimed is:

1. A management apparatus comprising:
at least one memory storing instructions, and
at least one processor configured to execute the instructions to;
detect a first motion performed by a first worker and a second motion performed by a second worker different from the first worker, the first and second workers being included in an image obtained by capturing a plurality of workers at a place where predetermined work is performed;
specify a correspondence including at least one of a time and a position of the first motion and the second motion;
calculate an appropriateness of the work based on the correspondence; and
output appropriateness information regarding the appropriateness.

2. The management apparatus according to claim 1, wherein the at least one processor is configured to execute the instructions to detect the first motion and the second motion similar to a predetermined registered motion.

3. The management apparatus according to claim 2, wherein the at least one processor is configured to execute the instructions to detect the first motion and the second motion from skeleton data regarding a structure of a body of the worker extracted from an image including the worker.

4. The management apparatus according to claim 3, wherein the at least one processor is configured to execute the instructions to detect the first motion and the second motion by comparing the skeleton data related to a motion of the worker with the skeleton data as the registered motion based on a form of each element forming the skeleton data.

5. The management apparatus according to claim 2, wherein
the at least one processor is configured to execute the instructions to detect a type of a motion performed by the worker based on the registered motion, and
calculate the appropriateness based on types of the first motion and the second motion and the correspondence.

6. The management apparatus according to claim 1, wherein the at least one processor is configured to execute the instructions to detect the first motion and the second motion from a posture change extracted in time series from each of a plurality of images captured at a plurality of different times.

7. The management apparatus according to claim 1, wherein the at least one processor is further configured to execute the instructions to store correspondence data related to the correspondence between the first motion and the second motion; and
calculate the appropriateness with reference to the correspondence data.

8. The management apparatus according to claim 1, wherein the at least one processor is configured to execute the instructions to calculate the appropriateness in a case where the predetermined first motion is detected and the second motion corresponding to the first motion is not detected to be lower than the appropriateness in a case where both the first motion and the second motion are detected.

9. The management apparatus according to claim 1, wherein
the at least one processor is configured to execute the instructions to calculate the appropriateness in a case where both the first motion and the second motion are detected and a positional relationship between the first motion and the second motion does not satisfy predetermined conditions
to be lower than the appropriateness in a case where both the first motion and the second motion are detected and the positional relationship between the first motion and the second motion satisfies the predetermined conditions.

10. The management apparatus according to claim 1, wherein the at least one processor is configured to execute the instructions to calculate the appropriateness in a case where both the first motion and the second motion are detected and a relationship in time series between the first motion and the second motion does not satisfy predetermined conditions to be lower than the appropriateness in a case where both the first motion and the second motion are detected and the relationship in time series between the first motion and the second motion satisfies the predetermined conditions.

11. The management apparatus according to claim 1, wherein the at least one processor is configured to execute the instructions to specify a related image showing a predetermined object or area related to the work; and
specify a positional relationship between the first motion and the second motion and the related image.

12. The management apparatus according to claim 1 wherein the at least one processor is configured to execute the instructions to output a predetermined warning signal in a case where the appropriateness is lower than a predetermined threshold value.

13. The management apparatus according to claim 12, wherein the at least one processor is configured to execute the instructions to output a plurality of warning signals corresponding to the appropriateness and outputs a warning signal corresponding to the appropriateness.

14. The management apparatus according to claim 12, wherein the at least one processor is configured to execute the instructions to specify a person who is the worker included in the image; and
output the warning signal corresponding to the worker with the low appropriateness in a case where the appropriateness is lower than the predetermined threshold value.

15. A management method
causing a computer to execute:
detecting a first motion performed by a first worker and a second motion performed by a second worker different from the first worker, the first and second workers being included in an image obtained by capturing a plurality of workers at a place where predetermined work is performed;
specifying a correspondence including at least one of a time and a position of the first motion and the second motion;
calculating an appropriateness of the work based on the correspondence; and
outputting appropriateness information regarding the calculated appropriateness.

16. A non-transitory computer-readable medium storing a program for causing a computer to execute a management method including:
detecting a first motion performed by a first worker and a second motion performed by a second worker different from the first worker, the first and second workers being included in an image obtained by capturing a plurality of workers at a place where predetermined work is performed;
specifying a correspondence including at least one of a time and a position of the first motion and the second motion;
calculating an appropriateness of the work based on the correspondence; and
outputting appropriateness information regarding the calculated appropriateness.
